(19) United States
(12) Patent Application Publication
(10) Pub. No.: US 2014/0338421 A1
(43) Pub. Date: Nov. 20, 2014

(54) DEVICE FOR TESTING PRESSURE SENSORS FOR INTERNAL COMBUSTION ENGINES

(71) Applicant: BorgWarner BERU Systems GmbH, Ludwigsburg (DE)

(72) Inventors: Jens Müller, Ludwigsburg (DE); Christian Pottiez, Eppingen (DE); Thomas Alban, Massenbachhausen (DE); Xaver Bösl, Moglingen (DE); Fabian Kunick, Marbach (DE); Dirk Wüstenhagen, Auma (DE)

(21) Appl. No.: 14/277,202

(22) Filed: May 14, 2014

(30) Foreign Application Priority Data
May 16, 2013 (DE) 10 2013 105 039.5

(51) Int. Cl. G01L 27/00; G01M 15/08

(52) U.S. Cl. CPC G01L 27/00; G01M 15/08
USPC 73/1.72

(57) ABSTRACT

The invention relates to a device for testing pressure sensors for internal combustion engines, comprising a pressure chamber, which has an inlet opening, an outlet opening, and a test opening for receiving a pressure sensor to be tested, a valve for opening and closing the inlet opening, and a valve for opening and closing the outlet opening. The valve for opening and closing the inlet opening comprises a rotatably mounted roll as a closing element. The roll has a radially continuous bore hole, wherein the bore hole is in line with the inlet opening in a first rotational angle position of the roll and the roll closes the inlet opening in a second rotational angle position.

### RELATED APPLICATIONS

This application claims priority to DE 10 2013 105 039.5, filed May 16, 2013, which is hereby incorporated herein by reference in its entirety.

### BACKGROUND

The invention relates to a device for testing pressure sensors for internal combustion engines.

Devices for testing pressure sensors for internal combustion engines have a pressure chamber, which comprises an inlet opening and an outlet opening and also a test opening for receiving a pressure sensor to be tested, and have a valve for opening and closing the inlet opening and a valve for opening and closing the outlet opening. A compressed gas source is connected to the inlet opening via the valve. By opening and closing the valve, a desired pressure is then set in the pressure chamber and can then be measured by the sensor to be tested.

For comprehensive testing of a pressure sensor for an internal combustion engine, it is not sufficient to expose the pressure sensor to statically different pressures which may occur in a combustion chamber of an internal combustion engine. More specifically, very quick pressure changes occur in the combustion chamber of an internal combustion engine, and therefore a pressure sensor for internal combustion engines has to respond just as quickly to pressure changes. In order to test a pressure sensor under dynamic conditions, that is to say to expose said pressure sensor repeatedly to short pressure pulses, rapidly switching electromagnetic valves are used in known devices. However, only a few pressure pulses per second can be achieved in this way at best, whereas up to 100 pressure changes per second may occur in an internal combustion engine of a vehicle.

### SUMMARY

The present invention provides a way in which shorter pressure pulses can be produced with a device for testing pressure sensors for internal combustion engines.

According to this disclosure, a rotatably mounted roll is used as a closing element of the inlet valve. The roll has a radially continuous bore hole. Depending on the rotational angle position of the roll, the through hole of the roll is in line with the inlet opening of the pressure chamber or the roll closes said opening. An opening of the pressure chamber can be opened and closed in very short intervals using such a roll. By means of the rotational speed, it is possible to adjust the frequency with which an opening of the pressure chamber is opened and closed per second.

Both the inlet valve for opening and closing the inlet opening and the outlet valve for opening and closing the outlet opening can have such a roll as a closing element. A significant improvement compared with known devices can be achieved even if only one of these two valves is formed by such a rotatably mounted roll.

If the inlet opening is arranged next to the outlet opening of the pressure chamber it is possible to provide both the valve for opening and closing the inlet opening and the valve for opening and closing the outlet opening with a single roll. For example, a roll may comprise two through holes, which are arranged at a distance from one another in the axial direction of the roll. One of these bore holes is associated with the inlet opening and the other bore hole is associated with the outlet opening. The two bore holes are preferably offset in relation to one another, for example offset in relation to one another by an angle of 90°. The outlet opening can thus be closed particularly easily if the inlet opening is opened, and vice versa.

It is also possible to provide a separate roll each for the valve for closing the inlet opening and for the valve for closing the outlet opening. In this case it is advantageous to mechanically couple the two rolls, such that a rotational movement of one of the two rolls is transmitted via a mechanical coupling to the other roll. A single motor is sufficient to drive both rolls. The coupling can be provided for example via a belt or a chain. Spur gears or sprocket gears are another possibility, for example.

In particular, an electric motor can be used for driving the roll or the rolls of a device according to this disclosure. If two rolls are provided, a single electric motor can be used to drive both rolls. It is also possible to provide each of the two rolls with its own electric motor. In this case an electronic control unit can be used which controls the two electric motors and therefore the rotational speed of the two rolls and the rotational angle position thereof relative to one another.

The closing element of a valve is sometimes referred to in the literature as a closing part, closing member or shut-off element. The purpose of the closing element is to shut off, in its closing position, a channel passing through the valve.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a schematic illustration of a device for testing pressure sensors for internal combustion engines; and

FIG. 2 shows a further example of a device for testing pressure sensors for internal combustion engines.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

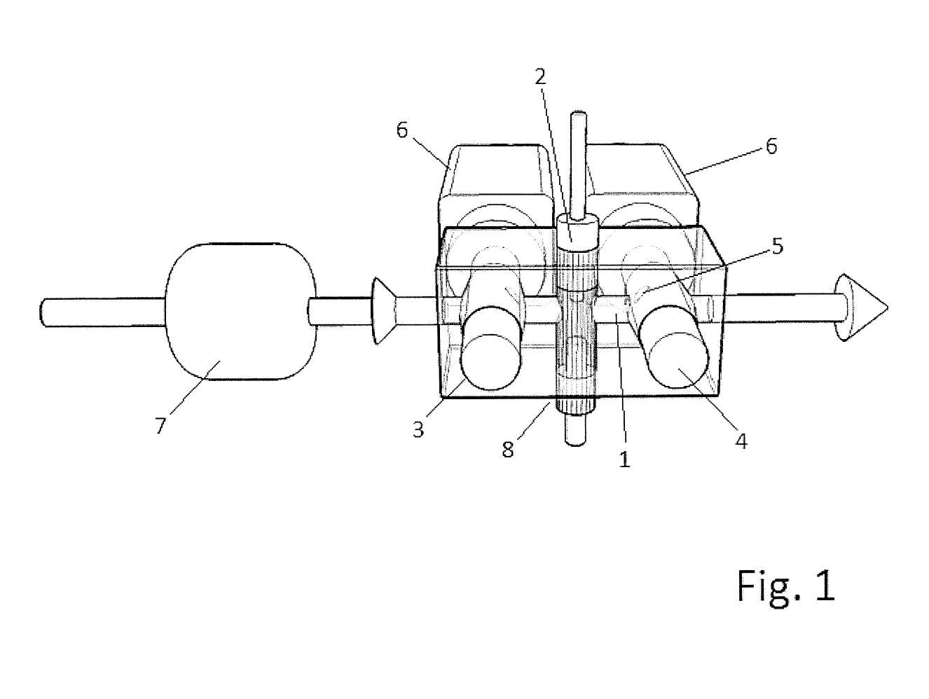

The device illustrated in FIG. 1 is used to test pressure sensors for internal combustion engines. The illustrated device has a pressure chamber 1, which comprises a test opening for receiving a pressure sensor 2 to be tested. An inlet opening of the pressure chamber 1 is opened and closed by a valve which comprises a roll as the closing element 3. A valve is arranged at an outlet opening of the pressure chamber 1. The closing element 4 of said valve is likewise a roll.

The two rolls 3, 4 are rotatably mounted and each comprise a bore hole 5 running transversely to their longitudinal direction. This through hole 5 is in line with the inlet and outlet opening of the pressure chamber 1 in a first rotational angle position. The roll 3, 4 closes the inlet and outlet opening in another rotational angle position. The inlet and outlet opening of the pressure chamber 1 can therefore be opened and closed in quick succession by rotating the rolls 3, 4. In the illustrated embodiment two electric motors 6 and each drive one of the two rolls 3, 4.

The inlet opening of the pressure chamber 1 is connected via the valve comprising the roll 3 to a pressure source 7, for example a compressed gas cylinder.

The pressure chamber 1 may additionally comprise a measuring opening, in which a reference sensor 8 is arranged, in order to measure the pressure in the pressure chamber. The pressure measurement sensor 2 to be tested can be tested or calibrated using the reference sensor 8.

The pressure chamber 1 may be formed as a channel, for example a bore in a body. Such a pressure chamber advantageously has such a small volume and can consequently be quickly filled and emptied again with little gas.

For example, the pressure chamber 1 may be formed by a metal body, e. g. a block, which comprises a continuous bore. A bore running transversely to the pressure chamber 1 may form a test opening for receiving a pressure senor 2 to be tested and/or for receiving a reference sensor 8. The rotatable rolls 3, 4 can be mounted rotatably in bores running transversely to the pressure chamber 1. The metal body then advantageously forms both the pressure chamber and the housing of both the inlet valve and the outlet valve.

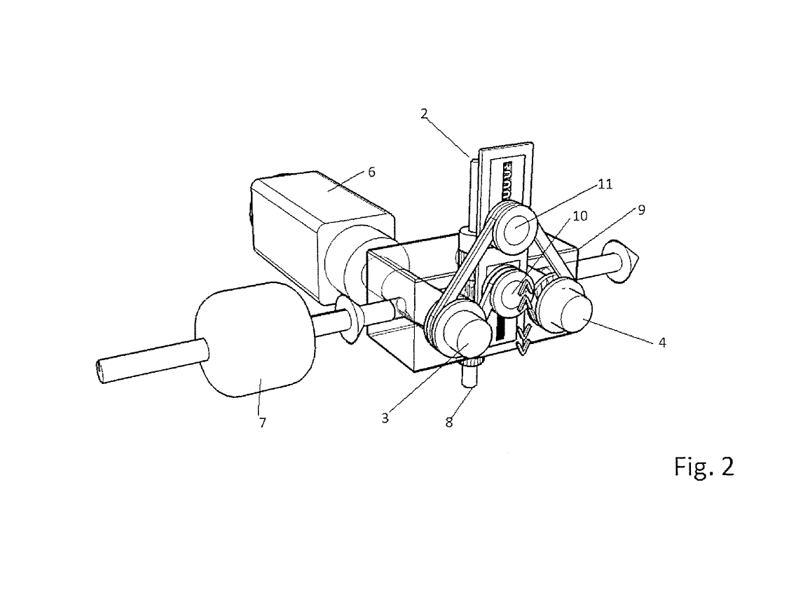

FIG. 2 shows a further illustrative embodiment of a device for testing pressure sensors for internal combustion engines. This device basically differs from the device illustrated in FIG. 1 merely in that a single electric motor 6 drives both the roll 3 which forms the closing element of the valve for opening and closing the inlet opening and the roll 4 which forms the closing element of the valve for opening and closing the outlet opening of the pressure chamber 1. The two rolls 3, 4 are mechanically coupled such that a rotational movement of the driven roll 3 is transmitted via a coupling element 9 to the other roll 4. A belt or a chain for example can be used as a coupling element 9.

The mechanical coupling between the two rolls 3, 4 can be adjusted in order to change the angular position of the two rolls 3, 4 relative to one another. To this end, a belt or a chain for example can be guided as a coupling element 9 via a guide element 10, 11, for example a pulley, of which the position is adjustable, for example by means of a shifting motion. In the shown example two guide elements 10, 11 are provided. The guide elements 10, 11 can be shifted transversely to a line defined by the two rolls 3, 4.

The angular position of the two rolls relative to one another is changed by changing the position of the guide element 10, 11. The pressure conditions prevailing in a combustion chamber of an engine can thus be even better simulated.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A device for testing pressure sensors for internal combustion engines, comprising:
a pressure chamber having an inlet opening, an outlet opening and a test opening, the test opening configured to receive a pressure sensor to be tested; and
a first valve for opening and closing the inlet opening and a second valve for opening and closing the outlet opening, the first valve comprising a rotatably mounted roll having a radially continuous bore hole;
wherein the roll has a first rotational angle position in which the bore hole is in line with the inlet opening and the inlet opening is open, and wherein the roll has a second rotational angle position in which the inlet opening is closed.

2. The device according to claim 1, wherein the second valve comprises a second rotatably mounted roll having a second radially continuous bore hole, wherein the second roll has a first rotational angle position in which the second bore hole is in line with the outlet opening and the outlet opening is open, and wherein the second roll has a second rotational angle position in which the outlet opening is closed.

3. The device according to claim 1, wherein the roll further comprises a second bore hole that can be aligned with the outlet opening, whereby rotation of the roll closes the first and second valves.

4. The device according to claim 1, wherein the roll comprises first and second rolls, the first roll being a closing element of the first valve and the second roll being a closing element of the second valve.

5. The device according to claim 4, wherein a rotational movement of one of the two rolls is transmitted via a mechanical coupling to the other roll.

6. The device according to claim 5, wherein the mechanical coupling comprises a belt or a chain.

7. The device according to claim 6, wherein the mechanical coupling is adjustable to change the angular position of the two rolls relative to one another.

8. The device according to claim 1, further comprising a reference sensor for measuring the pressure in the pressure chamber.

9. The device according to claim 1, wherein the pressure chamber is formed as a channel in a metal body and the test opening extends transversely to the channel.

10. The device according to claim 9, wherein the metal body forms the housing of the first valve, the metal body comprising an opening extending transversely to the channel for receiving the roll.

11. A device for testing pressure sensors for internal combustion engines, comprising:
a pressure chamber having an inlet, an outlet and a test opening, the test opening configured to receive a pressure sensor to be tested; and
a first valve for opening and closing the inlet and a second valve for opening and closing the outlet, the first valve comprising a roll having a bore, wherein the roll is rotatable between a first position in which the bore is aligned with and opens the inlet and a second position which closes the inlet.

12. The device according to claim 11, wherein the roll further comprises a second bore that can be aligned with the outlet, whereby rotation of the roll closes the first and second valves.

13. The device according to claim 11, wherein the roll comprises first and second rolls, the first roll being a closing element of the first valve and the second roll being a closing element of the second valve.

14. The device according to claim 13, wherein a rotational movement of one of the two rolls is transmitted via a mechanical coupling to the other roll.
